(19) United States
(12) Patent Application Publication
(10) Pub. No.: US 2004/0139840 A1
(43) Pub. Date: Jul. 22, 2004

(54) Drum rim guard and sound modifier

(76) Inventor: Randall L. May, Newport Beach, CA (US)

Correspondence Address: Neal J. Mosely, Patent Attorney, 6600 E. River Rd., Tucson, AZ, 85750, US

(21) Appl. No.: 10/660,237

(22) Filed: Sep. 11, 2003

Related U.S. Application Data
(63) Continuation of application No. 10/033,357, filed on Dec. 28, 2001, now abandoned.

(51) Int. Cl. G10D 13/02

(52) U.S. Cl. 84/417

(57) ABSTRACT

A drum assembly has a hollow drum shell with a drumhead and drum rim closing one or both end thereof and a guard member secured on one or both drum rims. The guard member is a sleeve member fitting over one or both edges of the drum dim and is secured thereon by setscrews or bolts and locknuts.

### CROSS REFERENCE TO COPENDING PATENT APPLICATIONS

This application is a continuation of applicant's copending application Ser. No. 10/033,357; filed Dec. 28, 2001.

### BACKGROUND OF THE INVENTION

1. Field of the Invention

This invention, relates to a new and improved drum assembly having a rim guard and sound modifier.

2. Brief Description of the Prior Art

Conventional drums consist of a hollow drum shell having one or more drumheads held in place by head rims. Conventional drums are usually not tunable except in a very narrow range by adjustment of the head rim. The rims are susceptible to damage in use and also when drums are stacked, especially the larger bass drums.

### SUMMARY OF THE INVENTION

It is therefore an object of the present invention to provide to provide a new and improved drum assembly having improved means for protecting the rim of a drum and providing a means for modification of the sound produced by a drummer.

Another object of this invention is to provide to provide a new and improved drum assembly having a guard for protecting th rim of a drum and providing a means for modification of the sound produced by a drummer.

Another object of the invention is to provide to provide a n w and improved drum assembly having a rim sleeve for protecting the rim of a drum and providing a means for modification of the sound produced by a drummer.

Another object of this invention is to provide to provide a new and improved drum assembly having improved means for repairing a damaged rim of a drum and providing a means for modification of the sound produced by a drummer.

Another object of this invention is to provide to provide a new and improved drum assembly having a rim sleeve means for repairing a damaged rim of a drum and providing a means for modification of the sound produced by a drummer.

Other objects of the invention will become apparent from time to time throughout the specification and claims as hereinafter related.

### BRIEF DESCRIPTION OF THE DRAWINGS

FIG. 1 is a view in elevation of a conventional drum assembly.

FIG. 2 is a plan view of the drum assembly shown in FIG. 1.

FIG. 3 is a partially exploded, isometric view of the outside of a standard drum assembly with a drum rim guard secured thereon.

FIG. 4 is a partially exploded, isometric view of the inside of the drum rim and guard shown in FIG. 3.

FIG. 5i an isometric view of a drum rim a in FIGS. 3 and 4 showing another embodiment of the rim guard.

FIG. 6 is an isometric view of th inside of the drum rim and guard shown in FIG. 5.

FIG. 7 is an edge view of the drum rim guard as shown in FIGS. 5 and 6.

FIG. 8 is an isometric view of the outside of a standard drum assembly with a drum rim guard securing damaged portions of the rim together.

FIG. 9 is a partially exploded, isometric view of the inside of the drum rim and guard shown in FIG. 7.

### DESCRIPTION OF ONE PREFERRED EMBODIMENT

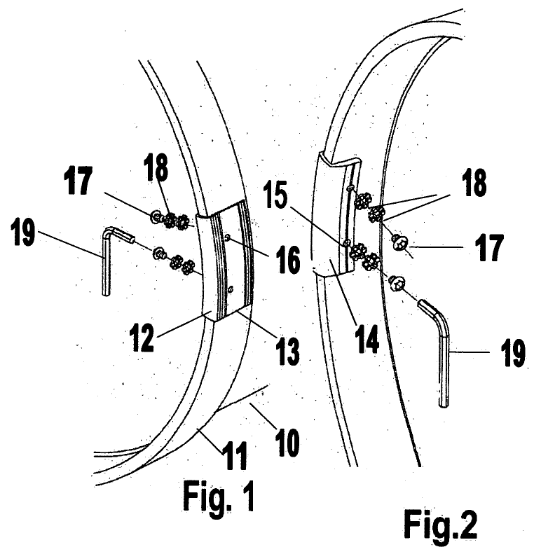

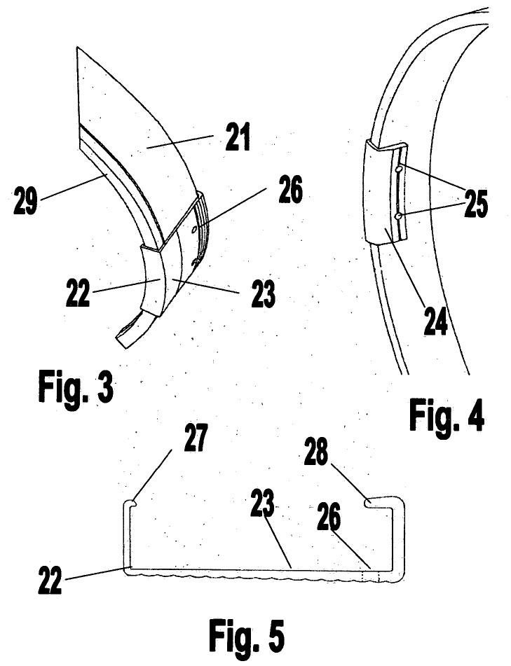

Referring to the drawings by numerals of reference, and more particularly to FIGS. 1 and 2, there is shown a drum 10 having a rim 11 and drumhead 2. Drum 10 is a bass drum, although the invention may be used with snare drums and other drums. In FIG. 3, the drum 10 is shown lying on its side and, when assembled, has drumheads 2 that are supported on the drum shell. The drumheads 2 are secured on the drum shell by rims 11.

Drum rim 11 has a rim guard 12 secured thereon which comprises a channel-shaped sleeve member having one side 13 longer than the other side 14, rim guard sleeve 12 has aligned holes 15 and 16 in sides 14 and 13 respectively. Rim guard sleeve 12 is seed by set screws 17 which extend through washers 18 into holes 15 and are tightened by Allen wrench 19 (or equivalent) until they bottom out against the surface of drum rim 11.

### Assembly And Operation

The assembly of the drum rim guard should be obvious but will be described for further clarity. Drum rim guard sleeve 12 is manufactured as a metal extrusion and cut to desired length. Holes 16 are drilled in side 13 and used as pilot holes for locating holes 15 in side 14. Holes 15 are threaded to receive the setscrews 17 for tightening the rim guard on the drum rim 11. When this drum rim guard is installed on a drum, it protects the drum rims against damage during stacking and provides a modification of the sound produced by the drum. Drummers will usually beat the drumhead at various positions for desired effect and often beat the drum rim. When they strike the rim guard 11, they get a further desirable modification of the sound produced.

### Description of Another Embodiment

In FIGS. 5-7, there is illustrated another embodiment of the rim guard which fits around both edges of the drum rim.

Referring to the drawings by numerals of reference, and more particularly to FIGS. 5 and 6, there is shown a drum rim 21. The drum is a bass drum, although the invention may be used with snare drums and other drums. In FIG. 5, the drum is lying on its side and, when assembled, has drumheads that are supported on the drum shell. The drumheads are secured on the drum shell by rims 21.

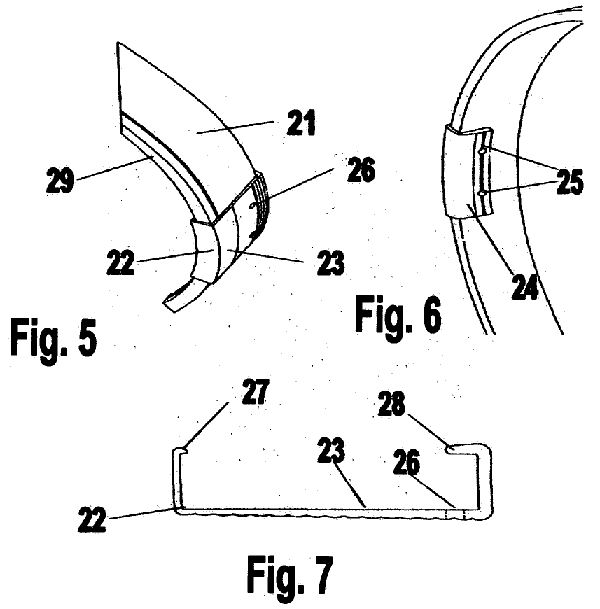

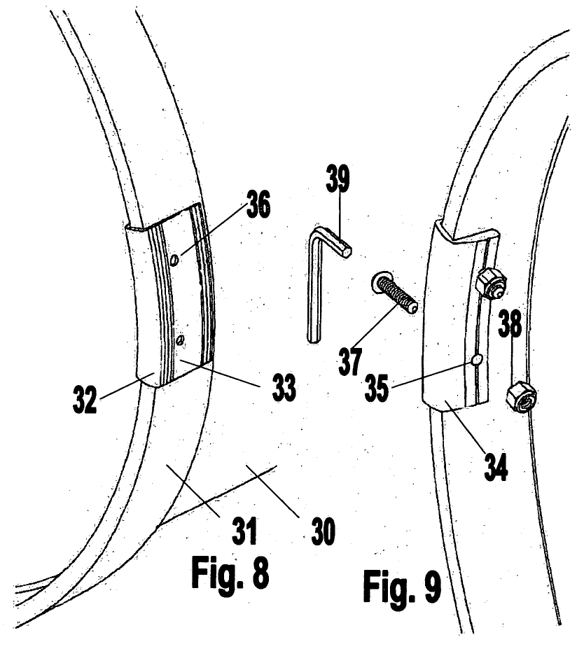

Drum rim 21 has a rim guard 22 secured thereon which comprise a channel shaped sleeve member having one side 23 with end portions 24 formed outwardly and inturned portion 27 and 28 (FIG. 7). Rim guard sleeve 22 has aligned holes 25 and 26 in sides 28 and 13 respectively. Rim guard sleeve 22 is secured by a snap fit over the rim 21 and, when desired, by setscrews which extend through washers into holes 25 and are tightened by Allen wrench (or equivalent) until they bottom out against the surface of drum rim 21.

### Assembly and Operation

The assembly of this drum rim guard should be obvious but will be described for further clarity. Drum rim guard sleeve 22 is manufactured as a metal extrusion and cut to desired length. Holes 26 are drilled in side 23 and used as pilot holes for locating holes 25 in side portion 28. Holes 25 are threaded to receive setscrews for tightening the rim guard on the drum rim. This drum rim guard may also be installed on a drum with edge portions 27 and 28 hooked around drum rim 21 without the need for setscrews. It protects the drum rim against damage during stacking and provides a modification of the sound produced by the drum. Drummers will usually beat the drumhead at various positions for desired effect and often beat the drum rim. When they beat on the rim guard, they get a further desirable modification of the sound produced.

### Description of a Further Embodiment

In FIGS. 8-9, there is illustrated a further embodiment of the rim guard which protects a damaged or fractured drum rim.

Referring to th drawings by numeral of reference, and more particularly to FIGS. 8 and 9, th re is shown a drum rim 31. Th drum is a bass drum, although the invention may be used with snare drums and other drums. In FIG. 8, the drum 30 is lying on its side and, when assembled, has drumheads that are supported on the drum shell. The drumheads are secured on the drum shell by rims 31.

Drum rim 31 has a rim guard 32 secured thereon which comprises a channel shaped sleeve member having one side 33 longer than the other side 34, rim guard sleeve 32 has aligned holes 35 and 36 in sides 34 and 33 respectively. Rim guard sleeve 32 is secured by bolts 37 which extend through optional washers through holes 36 and 35 and are secured by locknuts 38. Bolts 37 are tightened by Allen wrench 39 (or equivalent) and the locknuts 38 held by a wrench until tight.

### Assembly and Operation

The assembly of this drum rim guard should be obvious but will be described for further clarity. Drum rim guard sleeve 32 is manufactured as a metal extrusion and cut to desired length. Holes 36 are drilled in side 33 and used as pilot holes for locating holes 35 in side portion 34. Holes 35 and 36 are smooth to receive bolts 37 for securing the rim guard on the drum rim. When this drum rim guard is installed on a drum, it repairs damage or breakage of the drum rim. As in the other embodiments, it protects against damage during stacking and provides a modification of the sound produced by the drum. Drummers will usually beat the drumhead at various positions for desired effect and often beat the drum rim. When they beat on the rim guard, they get a further desirable modification of the sound produced.

While this invention has been described fully and completely with special emphasis upon several preferred embodiments, it should be understood that within the scope of the appended claims, the invention can be practiced otherwise than as specifically described herein.

1. A drum assembly and a drum rim guard comprising
a hollow drum shell,
a rim and drumhead closing each end of said drum shell,
a drum rim guard secured at a selected position on one of the drum rims protecting the rim of the drum against damage and providing a desired modification of the sound produced by the drum when struck by the drummer, and
said drum rim guard comprising a sleeve member having a length of only a small fraction of the circumference of said drum rim, fitting over one edge of said drum rim and secured directly thereto by means engaging only said drum rim.

2. A drum assembly according to claim 1 wherein
said drum rim guard comprises a sleeve member having end portions hooking over both edges of said drum rim to secure it directly thereto.

3. A drum assembly according to claim 1 wherein
said drum rim guard comprises a sleeve member fitting over only one edge of said one drum rim and having screw members extending through said sleeve member into said one drum ring to secure said sleeve member and drum ring directly together.

4. A drum assembly according to claim 1 wherein
said drum rim guard comprises a sleeve member fitting over on edge of said one drum rim and setscrews extending through one side of said sleeve member to engage said one drum ring to secure said sleeve member directly to said one drum rim.

5. A drum assembly according to claim 1 wherein
said drum rim guard comprises a sleeve member fitting over one edge of said one drum rim and bolts extending through said sleeve member and said one drum rim, and nuts positioned on said bolts to securing said sleeve member and drum rim together.

6. A drum assembly according to claim 1 wherein
said drum rim guard comprises a sleeve member hooking over both edges of said one drum rim, and setscrews extending through said sleeve member and engaging said drum rim to secure said sleeve member thereon.

7. A drum assembly according to claim 1 wherein
said drum rim guard comprises a sleeve member fitting over both edges of said one drum rim, bolts extending through said sleeve member and drum rim, and nuts positioned on said bolts to secure said sleeve member thereon.
